(19) United States
(12) Patent Application Publication
(10) Pub. No.: US 2012/0100944 A1
(43) Pub. Date: Apr. 26, 2012

(54) ELECTRICAL CONTROL BELT CONTINUOUSLY VARIABLE TRANSMISSION SYSTEM

(75) Inventors: Huan-Lung GU, Hsinchu (TW); Chin-Hone Lin, Hsinchu (TW); Pan-Hsiang Hsieh, Hsinchu (TW); Shao-Yu Li, Hsinchu (TW); Nan-Hsiung Tseng, Hsinchu (TW); Sen-Hsien Chang, Kaohsiung (TW); Chuan-Ming Su, (US); Chien-Hung Lai, (US)

(73) Assignees: Kwang Yang Motor Co., Ltd., Kaohsiung (TW); INDUSTRIAL TECHNOLOGY RESEARCH INSTITUTE, Hsinchu (TW)

(21) Appl. No.: 12/972,763

(22) Filed: Dec. 20, 2010

(30) Foreign Application Priority Data
Oct. 25, 2010 (TW) 099136286

(51) Int. Cl. F16H 59/00; F16H 55/56

(52) U.S. Cl. 474/46; 474/8

(57) ABSTRACT

An electrical control belt continuously variable transmission system controls a movable driving half-pulley or movable driven half-pulley initiatively, by changing a driving interval between the movable driving half-pulley and a fixed driving half-pulley or a driven interval between the movable driven half-pulley and a fixed driven half-pulley, respectively, depending on different statuses, in order to adjust a velocity ratio. By manipulating the movable driving half-pulley or the movable driven half-pulley, the system may further form a driving gap between the movable driving half-pulley and a transmission belt or a driven gap between the movable driven half-pulley and the transmission belt, such that the power is cut off. Clamping the movable driving half-pulley or the movable driven half-pulley to the transmission belt may restore the outputting of the power.

### TECHNICAL FIELD

The disclosure relates to electrical control belt continuously variable transmission (CVT) systems, and particularly, to an electrical control belt continuously variable transmission system that may adjust a velocity ratio and control powering on/off, without using a centrifugal block or a clutch.

### BACKGROUND

A conventional belt continuous variable transmission system uses a fixed driving half-pulley and a movable driving half-pulley to clamp one end of a transmission belt, and uses a fixed driven half-pulley and a movable driven half-pulley to clamp the other end of the transmission belt, to enable the transmission belt to transmit a rotating power input by an input shaft to a output shaft.

In the conventional belt continuous variable transmission system, a centrifugal block is installed in the movable driving half-pulley that may apply a push force to the movable driving half-pulley according to the rotation speed of an engine. The movable driven half-pulley may obtain the push force from a corresponding torsion spring. When the movable driving half-pulley moves due to the push force applied by the centrifugal block, an effective interval between the movable driving half-pulley and the fixed driving half-pulley changes accordingly, such that the position of the transmission belt also changes. When the push force applied by the centrifugal block balances with the push force generated by the torsion spring, the position of transmission belt stops changing. Accordingly, the velocity ratio is changed.

However, since the push force applied by the centrifugal block is limited by the rotation speed of the engine, the conventional belt continuous variable transmission system with the centrifugal block installed cannot change the velocity ratio according to the road conditions. It is very inconvenient for the designer if the velocity ratio cannot change with the road conditions. Besides, the torsion spring employed in the conventional belt continuous variable transmission system may cause the belt to be in no contact with the belt half-pulley.

A variable transmission system that electrically controls the movable driving half-pulley and the movable driven half-pulley comes to the market, in order to solve the above problems. Taiwanese Patent No. 1314199 discloses a variable transmission system that uses one or two electric motors to replace the conventional centrifugal block or torsion spring, to control the movable driving half-pulley and the movable driven half-pulley. However, the variable transmission system, though solving the problem that the belt is in no contact with the belt half-pulley because it does not include the torsion spring, cannot perform cutting off or restoring power without a costly, bulky and sophisticated clutch. Therefore, the convention variable transmission system cannot meet the modern design demands.

### SUMMARY

In view of the above-mentioned problems of the prior art, it is a primary objective of the disclosure to provide a variable transmission system without a centrifugal block.

It is another objective of the disclosure to provide a variable transmission system that may avoid the structural damages and accidental conditions due to torsion impacts.

It is yet another objective of the disclosure to provide a variable transmission system that may achieve cutting off and restoring power, without using a clutch.

The disclosure provides an electrical control belt continuously variable transmission system, which includes: a transmission belt having a driving end and a driven end; a input shaft for inputting a rotating power; a fixed driving half-pulley fixed to and supported by the input shaft; a movable driving half-pulley installed on the input shaft in a manner that the movable driving half-pulley moves along an axial direction of the input shaft and synchronously rotates with a rotation of the input shaft; an output shaft for outputting the rotating power to an external load unit; a fixed driven half-pulley fixed to and supported by the output shaft; a movable driven half-pulley installed on the output shaft in a manner that the movable driven half-pulley moves along an axial direction of the output shaft and synchronously rotates with a rotation of the output shaft; a thruster installed on the output shaft for constantly applying toward the fixed driven half-pulley an acting force to the movable driven half-pulley, to enable the movable driven half-pulley and the fixed driven half-pulley to clamp the driven end of the transmission belt; and an electrical control device for applying an corresponding force to the movable driving half-pulley according to a control signal, to enable the movable driving half-pulley and the fixed driving half-pulley to clamp or loosen the driving end of the transmission belt.

In an embodiment, the movable driven half-pulley comprises a cam slot, and the thruster comprises a thrust block installed on the output shaft, a compression spring installed on the thrust block that keeps applying toward the fixed driven half-pulley the acting force to the movable driven half-pulley, and a cam pin that cooperates with the cam slot, to enable the driven end of the transmission belt to be clamped by the movable driven half-pulley and the fixed driven half-pulley securely, and to avoid the transmission belt from slipping.

The disclosure further provides an electrical control belt continuously variable transmission system, which includes: a transmission belt having a driving end and a driven end; a input shaft for inputting a rotating power; a fixed driving half-pulley fixed to and supported by the input shaft; a movable driving half-pulley installed on the input shaft in a manner that the movable driving half-pulley moves along an axial direction of the input shaft and synchronously rotates with a rotation of the input shaft; a output shaft for outputting the rotating power to an external load unit; a fixed driven half-pulley fixed to and supported by the output shaft; a movable driven half-pulley installed on the output shaft in a manner that the movable driven half-pulley moves along an axial direction of the output shaft and synchronously rotates with a rotation of the output shaft; a thruster installed on the input shaft for applying toward the fixed driving half-pulley an acting force to the movable driving half-pulley, to enable the movable driving half-pulley and the fixed driving half-pulley to clamp the driving end of the transmission belt; and an electrical control device for applying an corresponding force to the movable driven half-pulley according to a control signal, to enable the movable driven half-pulley and the fixed driven half-pulley to clamp or loosen the driven end of the transmission belt.

In an embodiment, the movable driving half-pulley comprises a cam slot, and the thruster comprises a thrust block installed on the input shaft, a compression spring installed on the thrust block that keeps applying toward the fixed driving half-pulley the acting force to the movable driving half-pulley, and a cam pin that cooperates with the cam slot, to enable the driving end of the transmission belt to be clamped by the movable driving half-pulley and the fixed driving half-pulley securely, and to avoid the transmission belt from slipping.

The disclosure yet further provides an electrical control belt continuously variable transmission system, which includes: a transmission belt having a driving end and a driven end; a input shaft for inputting a rotating power; a fixed driving half-pulley fixed to and supported by the input shaft; a movable driving half-pulley installed on the input shaft in a manner that the movable driving half-pulley moves along an axial direction of the input shaft and synchronously rotates with a rotation of the input shaft; a output shaft for outputting the rotating power to an external load unit; a fixed driven half-pulley fixed to and supported by the output shaft; a movable driven half-pulley installed on the output shaft in a manner that the movable driven half-pulley moves along an axial direction of the output shaft and synchronously rotates with a rotation of the output shaft; a first electrical control device installed on the output shaft for applying toward the fixed driven half-pulley an acting force to the movable driven half-pulley, to enable the movable driven half-pulley and the fixed driven half-pulley to clamp the driven end of the transmission belt; and a second electrical control device for applying a corresponding force to the movable driving half-pulley according to a control signal, to enable the movable driving half-pulley and the fixed driving half-pulley to clamp or loosen the driving end of the transmission belt completely.

The disclosure may, without using a centrifugal block or a clutch, control a movable driving half-pulley or a movable driven half-pulley selectively, to change a driving interval between the movable driving half-pulley and a fixed driving half-pulley or a driven interval between the movable driven half-pulley and a fixed driven half-pulley. Therefore, the transmission belt may be clamped securely under any power transmission state. Accordingly, the structure damages and accidences due to the improper contact and bounce and torsion impacts of the belt and belt half-pulley may be avoided, when a user changes the velocity ratio initiatively according to road conditions. By controlling the movable driving half-pulley or the movable driven half-pulley initiatively, the electrical control belt continuously variable transmission system of the disclosure may also form gaps between the transmission belt and the movable driving half-pulley, or between the transmission belt and the movable driven half-pulley initiatively and quickly, in order to cut off power, without generating improper abrasion. Moreover, the electrical control belt continuously variable transmission system of the disclosure may enable at a certain time the movable driving half-pulley or the movable driven half-pulley to re-clamp the driving end or the driven end of the transmission belt, by having no gap. Therefore, the power may be restored, without the torsion impact and abrupt vibration.

### BRIEF DESCRIPTION OF DRAWINGS

The disclosure can be more fully understood by reading the following detailed description of the preferred embodiments, with reference made to the accompanying drawings, wherein:

FIG. 1A is a cross-sectional view of an electrical control belt continuously variable transmission system of a first embodiment according to the disclosure, the system operating in a speeding-up state;

FIG. 1B is a partial view of the system shown in FIG. 1A;

FIG. 1C is a schematic diagram of a movable driven half-pulley and a cam slot of the system shown in FIG. 1A;

FIG. 1D is a schematic diagram of a cam slot and a cam pin of the system shown in FIG. 1A when the cam slot is combined with the cam pin;

FIG. 2A is a cross-sectional view of the electrical control belt continuously variable transmission system of the first embodiment according to the disclosure, the system operating in a speeding-down state;

FIG. 2B is a partial view of the system shown in FIG. 2A;

FIG. 3 is a partially cross-sectional view of the electrical control belt continuously variable transmission system of the first embodiment according to the disclosure, the system operating in a power separation state;

FIG. 4 is a cross-sectional view and application schematic diagram of an electrical control belt continuously variable transmission system of a second embodiment according to the disclosure; and

FIG. 5 is a cross-sectional view and application schematic diagram of an electrical control belt continuously variable transmission system of a third embodiment according to the disclosure.

### DETAILED DESCRIPTION OF PREFERRED EMBODIMENTS

The following illustrative embodiments are provided to illustrate the disclosure of the disclosure, these and other advantages and effects can be apparently understood by those in the art after reading the disclosure of this specification. The disclosure can also be performed or applied by other different embodiments. The details of the specification may be on the basis of different points and applications, and numerous modifications and variations can be devised without departing from the spirit of the disclosure.

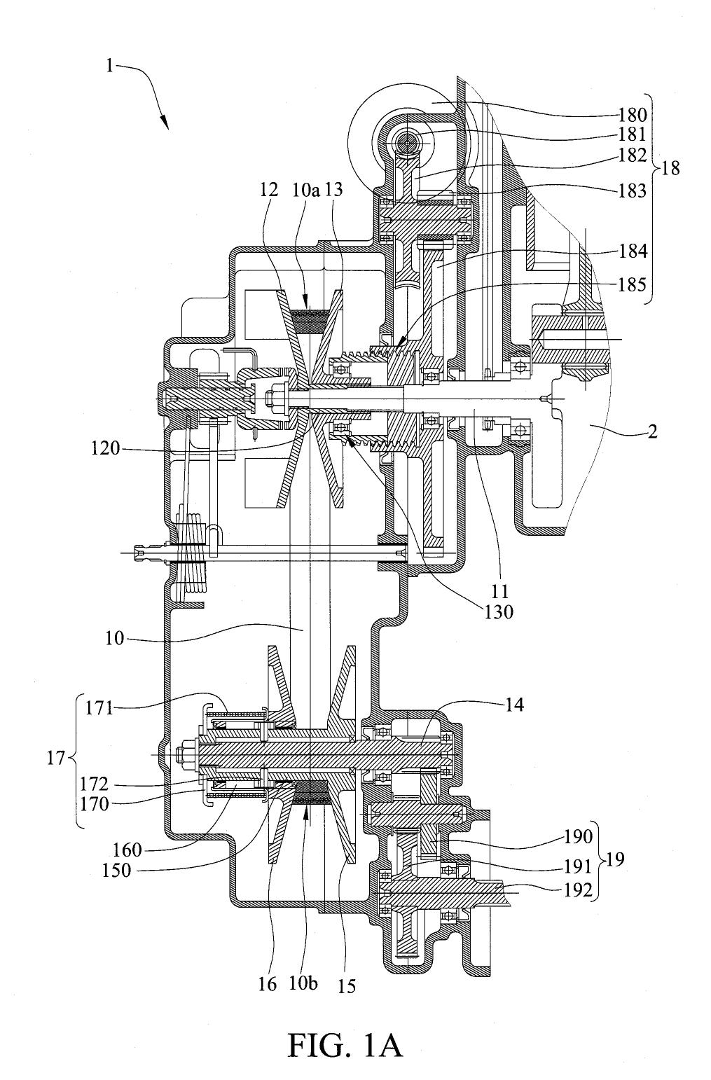

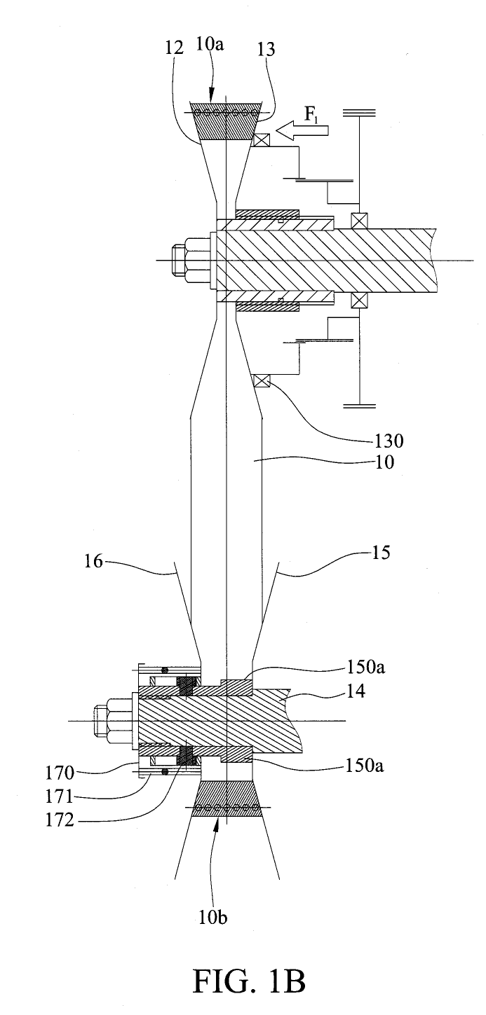

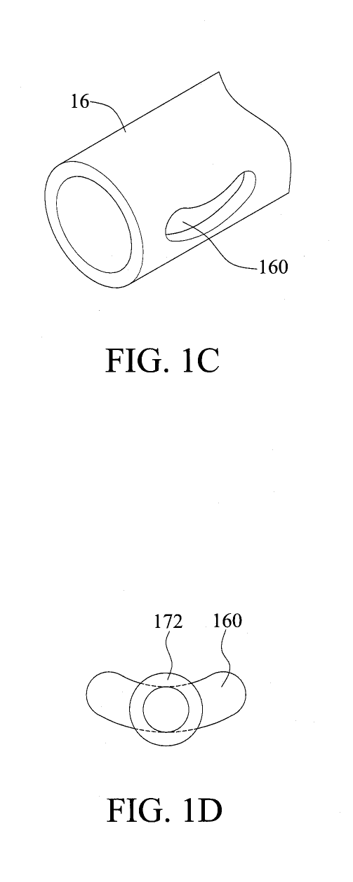

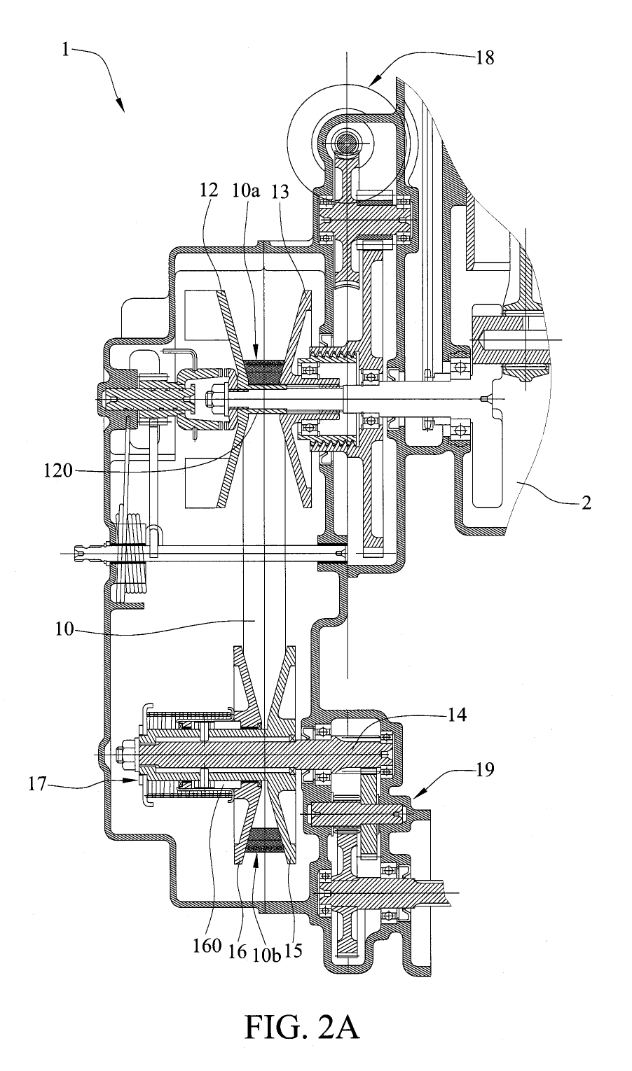

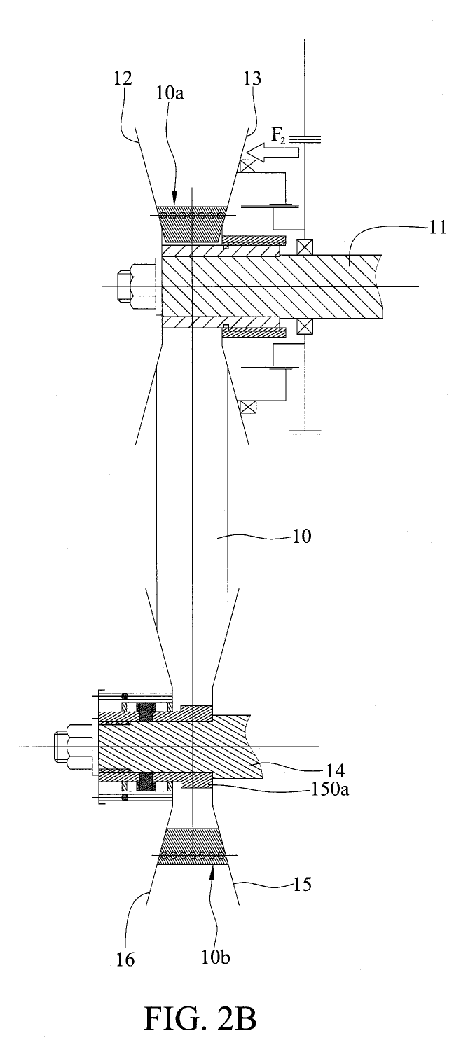

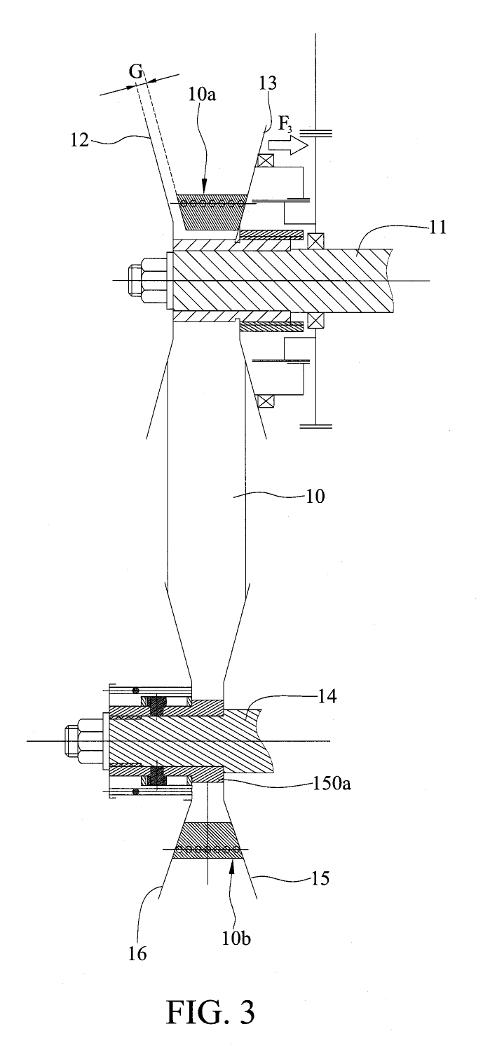

Refer collectively to FIG. 1A to FIG. 3 to understand an electrical control belt continuously variable transmission system 1 of a first embodiment according to the disclosure. FIG. 1A is a cross-sectional view of the electrical control belt continuously variable transmission system 1 of a first embodiment according to the disclosure, the system 1 operating in a speeding-up state. FIG. 1B is a partial view of the system 1 shown in FIG. 1A. FIG. 1C is a schematic diagram of a movable driven half-pulley and a cam slot of the system 1 shown in FIG. 1A. FIG. 1D is a schematic diagram of a cam slot and a cam pin of the system 1 shown in FIG. 1A when the cam slot is combined with the cam pin. FIG. 2A is a cross-sectional view of the electrical control belt continuously variable transmission system 1 of the first embodiment according to the disclosure, the system 1 operating in a speeding-down state. FIG. 2B is a partial view of the system shown in FIG. 2A. FIG. 3 is a partially cross-sectional view of the electrical control belt continuously variable transmission system 1 of the first embodiment according to the disclosure, the system 1 operating in a power separation state.

The electrical control belt continuously variable transmission system 1 comprises a transmission belt 10, an input shaft 11, a fixed driving half-pulley 12, a movable driving half-pulley 13, an output shaft 14, a fixed driven half-pulley 15, a movable driven half-pulley 16, a thruster 17, an electrical control device 18, and a gear box 19. The transmission belt 10 has a driving end 10a and a driven end 10b. A gap between the fixed driven half-pulley 15 and the output shaft 14 can be filled with lubricant (not shown).

The input shaft 11 is used for inputting a rotating power to the electrical control belt continuously variable transmission system 1. In the first embodiment, the input shaft 11 may be connected to a power unit, such as a combustion engine or an electric motor, and rotates based on the power provided by the power unit 2.

The fixed driving half-pulley 12 is fixed to and supported by the input shaft 11, and synchronously rotates with a rotation of the input shaft 11. In order to increase convenience of assembling the system 1, a fixed driving half-pulley boss 120 is installed in a half-pulley center region of the fixed driving half-pulley 12, such that the fixed driving half-pulley 12 may be fixed to and supported by the input shaft 11 through the fixed driving half-pulley boss 120.

The movable driving half-pulley 13 may be installed in the input shaft 11 in a manner that the movable driving half-pulley 13 may move along an axial direction of the input shaft 11 and synchronously rotates with a rotation of the input shaft 11. When the fixed driving half-pulley boss 120 is installed on the fixed driving half-pulley 12, the movable driving half-pulley 13 may be mounted to the fixed driving half-pulley boss 120 accordingly, and is therefore supported by the input shaft 11 in a manner that the movable driving half-pulley 13 may move along the axial direction of the input shaft 11.

The output shaft 14 outputs the rotating power input by the input shaft 11 to an external load unit (not shown). In the first embodiment, the load unit is a wheel or a generator. In order to meet various demands, the output shaft 14 may select two transmission gear units 190 and 191 and a transmission shaft 192 that are used for amplifying torsion to output the rotating power to the external load unit. In an embodiment of the disclosure, the transmission gear units 190 and 191 and the transmission shaft 192 may be integrated into the gear box 19. Alternatively, the output shaft 14 may be connected to the external load unit directly, without using the transmission gear units 190 and 191 and the transmission shaft 192.

The fixed driven half-pulley 15 is fixed to and supported by the output shaft 14. Similarly, a fixed driven half-pulley boss 150 may be also installed in a half-pulley center region of the fixed driven half-pulley 15, such that the fixed driven half-pulley 15 may be fixed to and supported by output shaft 14 through the fixed driven half-pulley boss 150.

The movable driven half-pulley 16 may be installed on the output shaft 14 in a manner that the movable driven half-pulley 16 moves along an axial direction of the output shaft 14 and synchronously rotates with a rotation of the output shaft 14. When the fixed driven half-pulley boss 150 is installed in a half-pulley center region of the fixed driven half-pulley 15, the movable driven half-pulley 16 may be mounted onto the fixed driven half-pulley boss 150 and supported by the output shaft 14 in the manner that the movable driven half-pulley 16 may move along the axial direction of the output shaft 14.

The thruster 17 is installed on the output shaft 14 for constantly applying, toward the fixed driven half-pulley 15, an acting force to the movable driven half-pulley 16, to enable the movable driven half-pulley 16 and the fixed driven half-pulley 15 to clamp, with their opposing V-shaped oblique surfaces, the V-shaped driven end 10b of the driven end 10b to a region between movable driven half-pulley 16 and the fixed driven half-pulley 15. In the first embodiment, the movable driven half-pulley 16 further comprises a cam slot 160 (at a position as shown in FIG. 2A and in a shaped as shown in FIG. 1C), and the thruster 17 may also comprise a thrust block 170 installed on the output shaft 14, a compression spring 171 installed on the thrust block 170 for constantly applying toward the fixed driven half-pulley 15 the acting force to the movable driven half-pulley 16, and a cam pin 172 for operatively interacting with the cam slot 160, so as to form a complete torsion cam mechanism as shown in FIG. 1D. Therefore, the driven end 10b of the transmission belt 10 may be securely clamped by the movable driven half-pulley 16 and the fixed driven half-pulley 15, so as to avoid the transmission belt 10 from slipping. In implementing the disclosure, through the collocation of the cam pin 172 and the cam slot 160, the electrical control belt continuously variable transmission system 1 of the disclosure may offset a torsion impact due to an abrupt change in loading, and prevent the structural damages and any accidental circumstances. Therefore, the driven end 10b of the transmission belt 10 is steadily clamped by the movable driven half-pulley 16 and the fixed driven half-pulley 15 all the time, and the safety risk is reduced accordingly.

The electrical control device 18 applies a corresponding force to the movable driving half-pulley 13 according to a control signal, to enable the movable driving half-pulley 13 and the fixed driving half-pulley 12 to clamp or loosen, with their opposing V-shaped oblique surfaces in various ways, the V-shaped driving end 10a of the transmission belt 10 to a region between the movable driving half-pulley 13 and the fixed driving half-pulley 12. In the first embodiment, the movable driving half-pulley 13 may comprise a thrust bearing 130, and the electrical control device 18 may comprise an electric motor 180, a worm 181, a worm gear 182, two gear reduction units 183 and 184, and a helical gear unit 185. The electric motor 180 drives the helical gear unit 185 to move according to the received control signal, through the interaction of the worm 181, the worm gear 182, and the gear reduction units 183 and 184. The helical gear unit 185 drives the movable driving half-pulley 13 to move axially. The helical gear unit 185 applies a force to the thrust bearing 130, and thus applies a corresponding force to the movable driving half-pulley 13. As such, the movable driving half-pulley 13 and the fixed driving half-pulley 12, which is spaced at different intervals, may clamp or loosen the driving end 10a of the transmission belt 10 completely.

With the input shaft 11 rotating at the same velocity ratio with the output shaft 14, the rotating input shaft 11 drives the fixed driving half-pulley 12 and the movable driving half-pulley 13 to rotate. Since the fixed driving half-pulley 12 and the movable driving half-pulley 13 clamp, with their opposing V-shaped oblique surfaces, the V-shaped surfaces of the driving end 10a of the transmission belt 10, and the fixed driven half-pulley 15 and the movable driven half-pulley 16 also clamp, with their opposing V-shaped oblique surfaces, the V-shaped surfaces of the driven end 10b of the transmission belt 10, the output shaft 14, the fixed driven half-pulley 15, and the movable driven half-pulley 16 may rotate with a rotation of the input shaft 11, allowing the external load unit to obtain the rotating power from the output shaft 14. When an active force applied by the electrical control device 18 balances with the active force applied by the thruster 17, an interval between the driving end 10a of the transmission belt 10 and the input shaft 11 may be approximately equal to an interval between the driven end 10b of the transmission belt 10 and the output shaft 14.

As shown in FIG. 1B, when the electrical control device 18 receives the control signal that is a speeding-up command, the electrical control device 18 increases the velocity ratio, that is, applying a first active force F₁ to the movable driving half-pulley 13. Accordingly, the helical gear unit 185 drives the movable driving half-pulley 13 to move axially toward the fixed driving half-pulley 12, to reduce the interval between the movable driving half-pulley 13 and the fixed driving half-pulley 12 gradually, such that the driving end 10a of the transmission belt 10 is pushed upward gradually, and is clamped to be close to a peripheral region of the movable driving half-pulley 13 and the fixed driving half-pulley 12. During the process, since the driving end 10a of the transmission belt 10 is clamped to be close to a region between the movable driving half-pulley 13 and the fixed driving half-pulley 12 gradually, the driven end 10b of the transmission belt 10 is pushed upward and close to an axis center of the output shaft 14, and clamped to move at a position close to a half-pulley center region between the movable driven half-pulley 16 and the fixed driven half-pulley 15. In other words, when the electrical control device 18 receives the control signal that is the speeding-up command, the whole transmission belt 10 is pushed upward gradually, the interval between the driving end 10a of the transmission belt 10 and the input shaft 11 increases, as compared with a general operation state, and the interval between the driven end 10b of the transmission belt 10 and the output shaft 14 decreases, as compared with the general operation state. At this moment, the output shaft 14 rotates faster, and faster than the input shaft 11. As a result, the operation speed of the load unit is increased. Moreover, since the electrical control belt continuously variable transmission system 1 of the disclosure may clamp both ends of the transmission belt 10 during the process, the tension of the transmission belt 10 is thus sustained, preventing the transmission belt 10 from being loosened or dropped. The balance between the active force applied by the electrical control device 18 and the active force applied by the thruster 17 indicates the velocity ratio is increased, and the whole transmission belt 10 is pushed upward. A threshold position to which the transmission belt 10 can be pushed corresponds to a so-called maximum variable speed ratio threshold position.

As shown in FIG. 2B, when electrical control device 18 receives the control signal that is a speeding-down command, the electrical control device 18 decreases the velocity ratio, that is applying to the movable driving half-pulley 13 a second active force F₂ smaller than the first active force F₁. At this moment, the helical gear unit 185 drives the movable driving half-pulley 13 to move axially in a direction away from the fixed driving half-pulley 12, so as to increase the interval between the movable driving half-pulley 13 and the fixed driving half-pulley 12, and push the driving end 10a of the transmission belt 10 downward and clamped to move at a position close to a half-pulley center region between the movable driving half-pulley 13 and the fixed driving half-pulley 12. During the process, since the driving end 10a of the transmission belt 10 is clamped to be close to the half-pulley center region between the movable driving half-pulley 13 and the fixed driving half-pulley 12, the driven end 10b of the transmission belt 10 is pushed downward accordingly and away from an axis center of the output shaft 14, and clamped to be close to a region between the movable driven half-pulley 16 and the fixed driven half-pulley 15 gradually. In other words, when the electrical control device 18 receives the control signal that is the speeding-down command, the whole transmission belt 10 is pushed downward. As a result, the interval between the driving end 10a of the transmission belt 10 between the input shaft 11 is increased, as compared to the general operation state, and the interval between the driven end 10b of the transmission belt 10 and the output shaft 14 is increased, as compared with the general operation state. At the same time, the output shaft 14 rotates slower, and slower than the input shaft 11. As such, the operation speed of the load unit is decreased. Since the electrical control belt continuously variable transmission system 1 may clamp both ends of the transmission belt 10 during the process, the tension of the transmission belt 10 may be sustained, preventing the transmission belt 10 from being loosened or dropped. The balance between the active force applied by the electrical control device 18 and the active force applied by the thruster 17 indicates that the velocity ratio is decreased, and the whole transmission belt 10 is pushed downward. A threshold position to which the transmission belt 10 is pushed downward is a so-called minimum variable speed ratio threshold location.

As shown in FIG. 3, when the electrical control device 18 receives the control signal that is a power separation command, the electrical control device 18 cuts off the power, that is applying to the movable driving half-pulley 13 a third active force F₃ in the opposite direction to the first active force F₁ and the second active force F₂. At this moment, the helical gear unit 185 drives the movable driving half-pulley 13 to move axially in a direction away from the fixed driving half-pulley 12, such that the movable driving half-pulley 13 and the fixed driving half-pulley 12 loosen the driving end 10a of the transmission belt 10 completely. Accordingly, the driving end 10a of the transmission belt 10 moves toward the input shaft 11. In other words, the movable driving half-pulley 13 or the fixed driving half-pulley 12 and the transmission belt 10 are spaced at a gap G. At the same time, the driven end 10b of the transmission belt 10 is still clamped by the movable driven half-pulley 16 and the fixed driven half-pulley 15 to be close to a region between the movable driven half-pulley 16 and the fixed driven half-pulley 15. By comparison of the state depicted in FIG. 3 with the state depicted in FIG. 2B, it is known that the interval between the movable driving half-pulley 13 and the fixed driving half-pulley 12 when the electrical control device 18 receives the power separation command is further increased, as compared with the interval between the movable driving half-pulley 13 and the fixed driving half-pulley 12 when the electrical control device 18 receives the speeding-down command, and, as such, the gap G exists between the transmission belt 10 and the fixed driving half-pulley 12. In other words, the disclosure may further increase the interval between the movable driving half-pulley 13 and the fixed driving half-pulley 12, when the whole transmission belt 10 approaches the so-called minimum variable speed ratio threshold location. At this moment, the movable driving half-pulley 13 and the fixed driving half-pulley 12 do not clamp the driving end 10a of the transmission belt 10, and the rotating power input by the input shaft 11 cannot be transmitted to the output shaft 14, which is equivalent to cutting off power. During the course of cutting off power, since the driven end 10b of the transmission belt 10 is still clamped by the movable driven half-pulley 16 and the fixed driven half-pulley 15 and its rotation inertia still drives the transmission belt 10, the transmission belt 10 is easily to cause undesired attrition against the movable driving half-pulley 13 and the fixed driving half-pulley 12, and the transmission belt 10 is likely to be damaged. In order to prevent the occurrence of this scenario, the electrical control device 18, when receiving the power separation command, may increase the interval between the movable driving half-pulley 13 and the fixed driving half-pulley 12 quickly, such that the transmission belt 10 is unlikely to introduce undesired attrition against the movable driving half-pulley 13 and the fixed driving half-pulley 12. Additionally, a bump 150a may be installed on the fixed driven half-pulley boss 150 of the fixed driven half-pulley 15, to act as a threshold position to which the movable driven half-pulley 16 may move along the axial direction of the output shaft 14, such that the probability further increases for the transmission belt 10 causing undesired attrition against the movable driving half-pulley 13 and thus the fixed driving half-pulley 12.

During the cutting off power state, the electrical control device 18, if receiving the control signal that is a power restoration command, may further apply a fourth active force (not shown) to the movable driving half-pulley 13, and, at a certain time (e.g., 0.4-0.8 second), the helical gear unit 185 drives the movable driving half-pulley 13 to move axially toward the fixed driving half-pulley 12, allowing the movable driving half-pulley 13 and the fixed driving half-pulley 12 to re-clamp the driving end 10a of the transmission belt 10 smoothly, and vanishing the gap G. In other words, the driving end 10a of the transmission belt 10 is clamped again, in a form without the gap G, to be close to the half-pulley center region between the movable driving half-pulley 13 and the fixed driving half-pulley 12.

Accordingly, the whole transmission belt 10 returns to the so-called minimum variable speed ratio threshold location, and the rotating power may be re-transmitted to the load unit smoothly, so as to achieve the effect of power restoration. Therefore, since the disclosure may re-transmit the rotating power smoothly, the unnecessary abrasion between the transmission belt 10, the movable driving half-pulley 13 and the fixed driving half-pulley 12 during the power restoration process may be avoided, and the accompanying torsion impact and abrupt vibration that should have occurred during the power restoration process are reduced effectively.

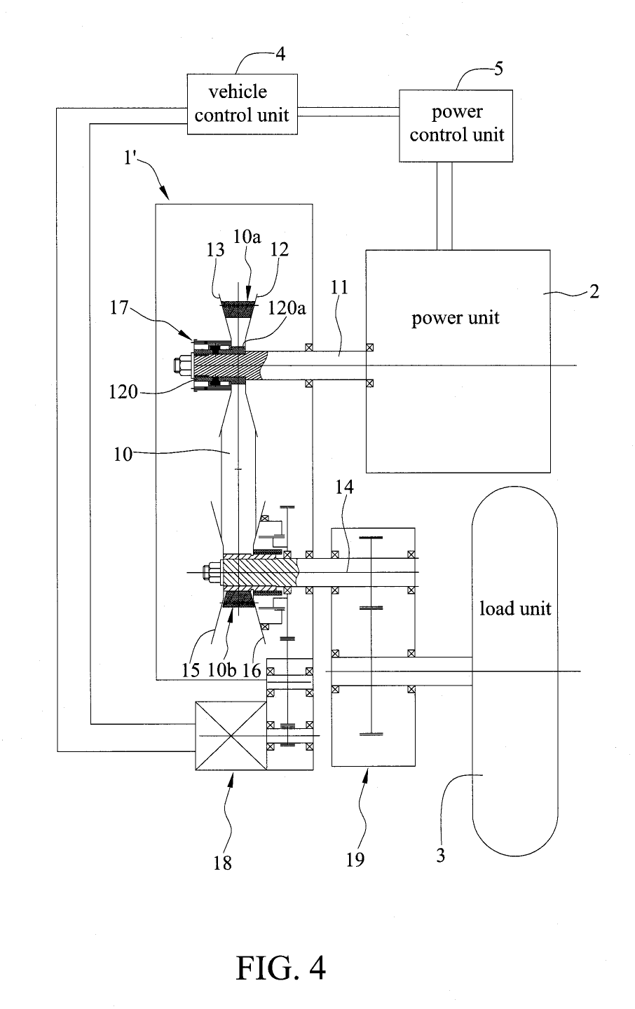

Now refer to the cross-sectional view and application schematic diagram of FIG. 4, in order to understand an electrical control belt continuously variable transmission system 1′ of a second embodiment according to the disclosure. The electrical control belt continuously variable transmission system 1′ comprises the transmission belt 10, the input shaft 11, the fixed driving half-pulley 12, the movable driving half-pulley 13, the output shaft 14, the fixed driven half-pulley 15, the movable driven half-pulley 16, the thruster 17, the electrical control device 18 and the gear box 19.

The second embodiment differs from the first embodiment in the arrangement of the thruster 17 and the electrical control device 18, the installation locations of the fixed driving half-pulley 12 and the movable driving half-pulley 13, and the installation locations of the fixed driven half-pulley 15 and the movable driven half-pulley 16, wherein the thruster 17 is still a spring torsion cam mechanism. The thruster 17 pushes the movable driving half-pulley 13, and enables the fixed driving half-pulley 12 and the movable driving half-pulley 13 to contact the belt, even if the fixed driving half-pulley 12 and the movable driving half-pulley 13 suffer a great torsion change at a bearing load end. The speeding-up, speeding-down, power separation and power restoration mechanism of the second embodiment are similar to those of the first embodiment. The second embodiment differs from the first embodiment in that the second embodiment keeps enabling the fixed driving half-pulley 12 and the movable driving half-pulley 13 to clamp the driving end 10a of the transmission belt 10, and changes the interval between the fixed driven half-pulley 15 and the movable driven half-pulley 16 initiatively, in order to enable the fixed driven half-pulley 15 and the movable driven half-pulley 16 to clamp or loose the driven end 10b of the transmission belt 10 completely. The main difference of the second embodiment from the first embodiment is described in the following paragraphs.

In the second embodiment, the fixed driving half-pulley 12 and the movable driven half-pulley 16 are installed on the right-hand side, while the movable driving half-pulley 13 and the fixed driven half-pulley 15 are installed on the left-hand side. In the second embodiment, the thruster 17 is installed on the input shaft 11, rather than installed on the output shaft 14, and applies toward the fixed driving half-pulley 12 an acting force to the movable driving half-pulley 13, to enable the movable driving half-pulley 13 and the fixed driving half-pulley 12 to clamp the driving end 10a of the transmission belt 10 in a region between the movable driving half-pulley 13 and the fixed driving half-pulley 12. In the second embodiment, the electrical control device 18 is installed on the output shaft 14, rather than installed on the input shaft 11, and thus applies a corresponding force to the movable driven half-pulley 16 according to the control signal, in order to enable the movable driven half-pulley 16 and the fixed driven half-pulley 15 to clamp or loose the driven end 10b of the transmission belt 10.

In the second embodiment, a power control unit 5 and a vehicle control unit 4 are connected to the power unit 2 and the electrical control device 18, respectively, and the vehicle control unit 4 may transmit different control signals to the electrical control device 18, in order to control the movable driven half-pulley 16 and change the interval between the movable driven half-pulley 16 and the fixed driven half-pulley 15, so as to perform the speeding-up, speeding-down, power separation, and power restoration operations, as described in the first embodiment.

In the second embodiment, the gear box 19 may be omitted, depending on practical demands. Accordingly, the output shaft 14 is connected to the load unit 3 directly. Of course, the vehicle control unit 4 and the power control unit 5 may be applied to the first embodiment.

In the second embodiment, since the movable driven half-pulley 16 is controlled by the electrical control device 18 initiatively, a bump 120a used for pre-propping the movable driving half-pulley 13 may be formed on the fixed driving half-pulley boss 120 of the fixed driving half-pulley 12, acting as a threshold position to which the movable driving half-pulley 13 moves along the axial direction of the input shaft 11 toward the fixed driving half-pulley 12.

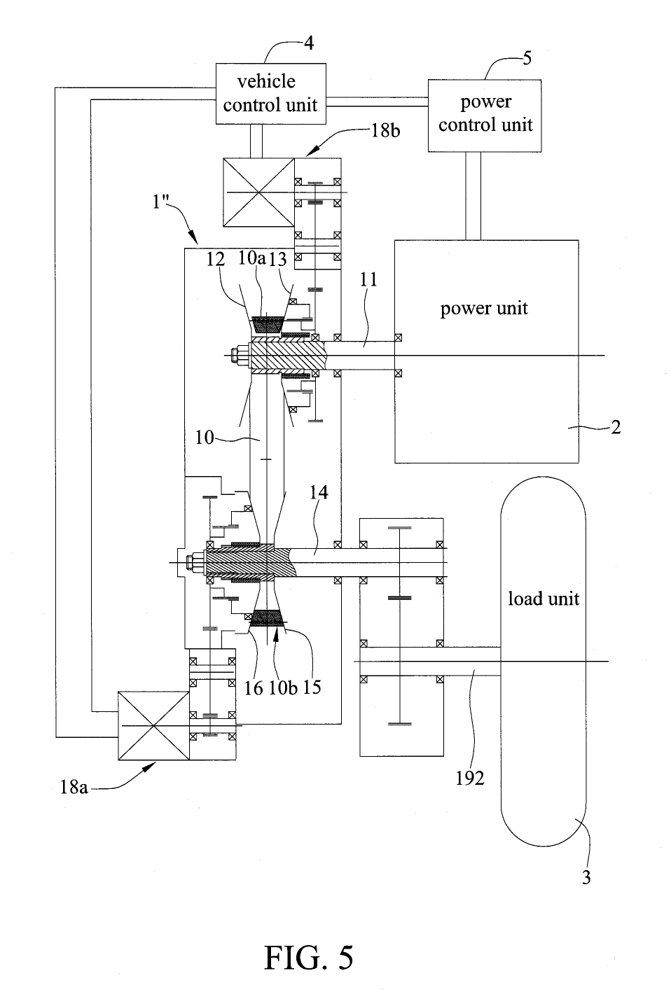

Further, FIG. 5 illustrates the cross-sectional view and application schematic diagram, to facilitate the understanding of an electrical control belt continuously variable transmission system 1″ of a third embodiment according to the disclosure. The electrical control belt continuously variable transmission system 1″ comprises the transmission belt 10, the input shaft 11, the fixed driving half-pulley 12, the movable driving half-pulley 13, the output shaft 14, the fixed driven half-pulley 15, the movable driven half-pulley 16, the thruster 17, the electrical control device 18 and the gear box 19.

The third embodiment differs from the first embodiment in that a first electrical control device 18a of the third embodiment replaces the thruster 17 of the first embodiment, so as to form a dual-electrical control device belt continuous variable transmission system. FIG. 5 does not show the torsion cam mechanism required in the thruster 17 to bear the abrupt torsion change at the load end, but shows a second electrical control device 18b, in place of the spring mechanism in the thruster 17. In implementing, the third embodiment may, however, include the torsion cam mechanism. The third embodiment have detailed structures and operations similar to those of the first embodiment, further description hereby omitted.

In order to address the installation of the dual electrical control devices, in the third embodiment the movable driven half-pulley 16 may comprise a first thrust bearing, and the first electrical control device 18a may comprise a first electric motor, a first worm, a first worm gear, a first gear reduction unit, and a first helical gear unit. The first electric motor drives the first helical gear unit through the interaction of the first worm, the first worm gear, and the first gear reduction unit, such that the first helical gear unit may apply a force to the first thrust bearing, and thus apply an acting force to the movable driven half-pulley 16. The movable driving half-pulley 13 may comprises a second thrust bearing, and the second electrical control device 18b may comprise a second electric motor, a second worm, a second worm gear, a second gear reduction unit, and a second helical gear unit. The second electric motor drives the second helical gear unit through the interaction of the second worm, the second worm gear, and the second gear reduction unit according to the received control signal, such that the second helical gear unit may apply a force to the second thrust bearing, and thus apply the corresponding force corresponding to the control signal to the movable driving half-pulley 13, in order to complete the changing operation in velocity ratio as described in the first embodiment.

In conclusion, the electrical control belt continuously variable transmission system of the disclosure may, without using a centrifugal block or a clutch, control a movable driving half-pulley or a movable driven half-pulley selectively, to change a driving interval between the movable driving half-pulley and a fixed driving half-pulley or a driven interval between the movable driven half-pulley and a fixed driven half-pulley. Therefore, the transmission belt may be clamped securely under any power transmission state. Accordingly, the structure damages and accidences due to the improper contact and bounce and torsion impacts of the belt and belt half-pulley may be avoided, when a user changes the velocity ratio initiatively according to road conditions.

By controlling the movable driving half-pulley or the movable driven half-pulley initiatively, the electrical control belt continuously variable transmission system of the disclosure may also form gaps between the transmission belt and the movable driving half-pulley, or between the transmission belt and the movable driven half-pulley initiatively and quickly, in order to cut off power, without generating improper abrasion.

Moreover, the electrical control belt continuously variable transmission system of the disclosure may enable at a certain time the movable driving half-pulley or the movable driven half-pulley to re-clamp the driving end or the driven end of the transmission belt, by having no gap. Therefore, the power may be restored, without the torsion impact and abrupt vibration.

Compared with the conventional variable transmission system that uses the centrifugal block to change the velocity ratio, or uses the electric motor and the clutch to cut off and restore power, the disclosure features the efficacies of requiring less space, reducing the cost, and simplifying the assembly process.

The foregoing descriptions of the detailed embodiments are only illustrated to disclose the features and functions of the disclosure and not restrictive of the scope of the disclosure. It should be understood to those in the art that all modifications and variations according to the spirit and principle in the disclosure of the disclosure should fall within the scope of the appended claims.

What is claimed is:

1. An electrical-control belt continuously variable transmission system, comprising:
a transmission belt having a driving end and a driven end;
an input shaft for inputting a rotating power;
a fixed driving half-pulley fixed to and supported by the input shaft;
a movable driving half-pulley installed on the input shaft in a manner that the movable driving half-pulley moves along an axial direction of the input shaft and synchronously rotates with a rotation of the input shaft;
an output shaft for outputting the rotating power to an external load unit;
a fixed driven half-pulley fixed to and supported by the output shaft;
a movable driven half-pulley installed on the output shaft in a manner that the movable driven half-pulley moves along an axial direction of the output shaft and synchronously rotates with a rotation of the output shaft;
a thruster installed on the output shaft for constantly applying toward the fixed driven half-pulley an acting force to the movable driven half-pulley, to enable the movable driven half-pulley and the fixed driven half-pulley to clamp the driven end of the transmission belt; and
an electrical control device for applying a corresponding force to the movable driving half-pulley according to a control signal, to enable the movable driving half-pulley and the fixed driving half-pulley to clamp or loosen the driving end of the transmission belt.

2. The electrical control belt continuously variable transmission system of claim 1, wherein, when the control signal is a speeding-up command, the electrical control device applies a first corresponding force to the movable driving half-pulley, to enable the movable driving half-pulley and the fixed driving half-pulley to clamp the driving end of the transmission belt to be close to a region between the movable driving half-pulley and the fixed driving half-pulley, and to enable the driven end of the transmission belt to be clamped by the movable driven half-pulley and the fixed driven half-pulley to be close to a half-pulley center region between the movable driven half-pulley and the fixed driven half-pulley.

3. The electrical control belt continuously variable transmission system of claim 1, wherein, when the control signal is a speed-down command, the electrical control device applies a second corresponding force to the movable driving half-pulley, to enable the movable driving half-pulley and the fixed driving half-pulley to clamp the driving end of the transmission belt to be close to a half-pulley center region between the movable driving half-pulley and the fixed driving half-pulley, and to enable the driven end of the transmission belt to be clamped by the movable driven half-pulley and the fixed driven half-pulley to be close to a region between movable driven half-pulley and the fixed driven half-pulley.

4. The electrical control belt continuously variable transmission system of claim 1, wherein, when the control signal is a power separation command, the electrical control device applies a third corresponding force to the movable driving half-pulley, to enable the movable driving half-pulley and the fixed driving half-pulley to loosen the transmission belt, to enable the driving end of the transmission belt to move toward the input shaft, and to enable the driven end of the transmission belt to be clamped by the movable driven half-pulley and the fixed driven half-pulley to be close to a region between the movable driven half-pulley and the fixed driven half-pulley; and, when the control signal is a power restoration command, the electrical control device applies a fourth corresponding force to the movable driving half-pulley, to enable the movable driving half-pulley and the fixed driving half-pulley to re-clamp the driving end of the transmission belt at a certain time to be close to a half-pulley center region between the movable driving half-pulley and the fixed driving half-pulley.

5. The electrical control belt continuously variable transmission system of claim 1, further comprising a fixed driving half-pulley boss installed in a half-pulley center region of the fixed driving half-pulley, wherein the fixed driving half-pulley is fixed to and supported by the input shaft by the fixed driving half-pulley boss, and the movable driving half-pulley is mounted onto the fixed driving half-pulley boss and is supported by the input shaft in a manner that the movable driving half-pulley moves along the axial direction of the input shaft; and a fixed driven half-pulley boss installed in a half-pulley center region of the fixed driven half-pulley, wherein the fixed driven half-pulley is fixed to and supported by the output shaft by the fixed driven half-pulley boss, and the movable driven half-pulley is mounted onto the fixed driven half-pulley boss and supported by the output shaft in a manner that the movable driven half-pulley moves along the axial direction of the output shaft.

6. The electrical control belt continuously variable transmission system of claim 5, further comprising a bump installed on the fixed driven half-pulley boss of the fixed driven half-pulley that pre-props against the movable driven half-pulley and acts as a threshold position to which the movable driven half-pulley moves along the axial direction of the output shaft toward the fixed driven half-pulley.

7. The electrical control belt continuously variable transmission system of claim 1, wherein the movable driven half-pulley comprises a cam slot, and the thruster comprises a thrust block installed on the output shaft, a compression spring installed on the thrust block that keeps applying toward the fixed driven half-pulley the acting force to the movable driven half-pulley, and a cam pin that cooperates with the cam slot, to enable the driven end of the transmission belt to be clamped by the movable driven half-pulley and the fixed driven half-pulley securely, and to avoid the transmission belt from slipping.

8. The electrical control belt continuously variable transmission system of claim 1, wherein the movable driving half-pulley comprises a thrust bearing, and the electrical control device comprises an electric motor, a worm, a worm gear, a gear reduction unit, and a helical gear unit, wherein the electric motor drives the helical gear unit to move axially through the worm, the worm gear and the gear reduction unit according to the control signal, such that the helical gear unit applies a force to the thrust bearing and thereby applies the corresponding force to the movable driving half-pulley.

9. The electrical control belt continuously variable transmission system of claim 1, wherein the output shaft outputs the rotating power to the external load unit by using a transmission gear unit and a transmission shaft that amplifies torsion.

10. An electrical control belt continuously variable transmission system, comprising:
a transmission belt having a driving end and a driven end;
an input shaft for inputting a rotating power;
a fixed driving half-pulley fixed to and supported by the input shaft;
a movable driving half-pulley installed on the input shaft in a manner that the movable driving half-pulley moves along an axial direction of the input shaft and synchronously rotates with a rotation of the input shaft;
an output shaft for outputting the rotating power to an external load unit;
a fixed driven half-pulley fixed to and supported by the output shaft;
a movable driven half-pulley installed on the output shaft in a manner that the movable driven half-pulley moves along an axial direction of the output shaft and synchronously rotates with a rotation of the output shaft;
a thruster installed on the input shaft for constantly applying toward the fixed driving half-pulley an acting force to the movable driving half-pulley, to enable the movable driving half-pulley and the fixed driving half-pulley to clamp the driving end of the transmission belt; and
an electrical control device for applying a corresponding force to the movable driven half-pulley according to a control signal, to enable the movable driven half-pulley and the fixed driven half-pulley to clamp or loosen the driven end of the transmission belt.

11. The electrical control belt continuously variable transmission system of claim 10, wherein, when the control signal is a speeding-up command, the electrical control device applies a first corresponding force to the movable driven half-pulley, to enable the movable driven half-pulley and the fixed driven half-pulley to clamp the driven end of the transmission belt to be close to a region between the movable driven half-pulley and the fixed driven half-pulley, and to enable the driving end of the transmission belt to be clamped by the movable driving half-pulley and the fixed driving half-pulley to be close to a half-pulley center region between the movable driving half-pulley and the fixed driving half-pulley.

12. The electrical control belt continuously variable transmission system of claim 10, wherein, when the control signals is a speeding-down command, the electrical control device applies a second corresponding force to the movable driven half-pulley, to enable the movable driven half-pulley and the fixed driven half-pulley to clamp the driven end of the transmission belt to be close to a half-pulley center region between the movable driven half-pulley and the fixed driven half-pulley, and to enable the driving end of the transmission belt to be clamped by the movable driving half-pulley and the fixed driving half-pulley to be close to a region between the movable driving half-pulley and the fixed driving half-pulley.

13. The electrical control belt continuously variable transmission system of claim 10, wherein, when the control signals is a power separation command, the electrical control device applies a third corresponding force to the movable driven half-pulley, to enable the movable driven half-pulley and the fixed driven half-pulley to loosen the transmission belt completely, to enable the driven end of the transmission belt to move toward the output shaft, and to enable the driving end of the transmission belt to be clamped by the movable driving half-pulley and the fixed driving half-pulley to be close to a region between the movable driving half-pulley and the fixed driving half-pulley; and, when the control signal is a power restoration command, the electrical control device applies a fourth corresponding force to the movable driven half-pulley, to enable the movable driven half-pulley and the fixed driven half-pulley to re-clamp the driven end of the transmission belt at a certain time to be close to a half-pulley center region between the movable driven half-pulley and the fixed driven half-pulley.

14. The electrical control belt continuously variable transmission system of claim 10, further comprising a fixed driving half-pulley boss installed in a half-pulley center region of the fixed driving half-pulley, wherein the fixed driving half-pulley is fixed to and supported by the input shaft by the fixed driving half-pulley boss, and the movable driving half-pulley is mounted onto the fixed driving half-pulley boss and is supported by the input shaft in a manner that the movable driving half-pulley moves along the axial direction of the input shaft; and a fixed driven half-pulley boss installed in a half-pulley center region of the fixed driven half-pulley, wherein the fixed driven half-pulley is fixed to and supported by the output shaft by the fixed driven half-pulley boss, and the movable driven half-pulley is mounted onto the fixed driven half-pulley boss and supported by the output shaft in a manner that the movable driven half-pulley moves along the axial direction of the output shaft.

15. The electrical control belt continuously variable transmission system of claim 14, further comprising a bump installed on the fixed driving half-pulley boss of the fixed driving half-pulley that pre-props against the movable driving half-pulley and acts as a threshold position to which the movable driving half-pulley moves along the axial direction of the input shaft toward fixed driving half-pulley.

16. The electrical control belt continuously variable transmission system of claim 10, wherein the movable driving half-pulley comprises a cam slot, and the thruster comprises a thrust block installed on the input shaft, a compression spring installed on the thrust block that keeps applying toward the fixed driving half-pulley the acting force to the movable driving half-pulley, and a cam pin that cooperates with the cam slot, to enable the driving end of the transmission belt to be clamped by the movable driving half-pulley and the fixed driving half-pulley securely, and to avoid the transmission belt from slipping.

17. The electrical control belt continuously variable transmission system of claim 10, wherein the movable driven half-pulley comprises a thrust bearing, and the electrical control device comprises an electric motor, a worm, a worm gear, a gear reduction unit, and a helical gear unit, wherein the electric motor drives the helical gear unit to move axially through the worm, the worm gear and the gear reduction unit according to the control signal, such that the helical gear unit applies a force to the thrust bearing, and thereby applies the corresponding force to the movable driven half-pulley.

18. The electrical control belt continuously variable transmission system of claim 10, wherein the output shaft outputs the rotating power to the external load unit by using a transmission gear unit and a transmission shaft that amplify torsion.

19. An electrical control belt continuously variable transmission system, comprising:
a transmission belt having a driving end and a driven end;
an input shaft for inputting a rotating power;
a fixed driving half-pulley fixed to and supported by the input shaft;
a movable driving half-pulley installed on the input shaft in a manner that the movable driving half-pulley moves along an axial direction of the input shaft and synchronously rotates with a rotation of the input shaft;
an output shaft for outputting the rotating power to an external load unit;
a fixed driven half-pulley fixed to and supported by the output shaft;
a movable driven half-pulley installed on the output shaft in a manner that the movable driven half-pulley moves along an axial direction of the output shaft and synchronously rotates with a rotation of the output shaft;
a first electrical control device installed on the output shaft for constantly applying toward the fixed driven half-pulley an acting force to the movable driven half-pulley, to enable the movable driven half-pulley and the fixed driven half-pulley to clamp the driven end of the transmission belt; and
a second electrical control device for applying a corresponding force to the movable driving half-pulley according to a control signal, to enable the movable driving half-pulley and the fixed driving half-pulley to clamp or loosen the driving end of the transmission belt completely.

20. The electrical control belt continuously variable transmission system of claim 19, wherein, when the control signal is a speeding-up command, the second electrical control device applies a first corresponding force to the movable driving half-pulley, to enable the movable driving half-pulley and the fixed driving half-pulley to clamp the driving end of the transmission belt to be close to a region between the movable driving half-pulley and the fixed driving half-pulley, and the first electrical control device enables the driven end of the transmission belt to be clamped by the movable driven half-pulley and the fixed driven half-pulley to be close to a half-pulley center region between the movable driven half-pulley and the fixed driven half-pulley.

21. The electrical control belt continuously variable transmission system of claim 19, wherein, when the control signal is a speeding-down command, the second electrical control device applies a second corresponding force to the movable driving half-pulley, to enable the movable driving half-pulley and the fixed driving half-pulley to clamp the driving end of the transmission belt to be close to a half-pulley center region between the movable driving half-pulley and the fixed driving half-pulley, and the first electrical control device enables the driven end of the transmission belt to be clamped by the movable driven half-pulley and the fixed driven half-pulley to be close to a region between the movable driven half-pulley and the fixed driven half-pulley.

22. The electrical control belt continuously variable transmission system of claim 19, wherein, when the control signal is a power separation command, the second electrical control device applies a third corresponding force to the movable driving half-pulley, to enable the movable driving half-pulley and the fixed driving half-pulley to loose the transmission belt and to enable the driving end of the transmission belt to move toward the input shaft, and the first electrical control device enables the driven end of the transmission belt to be clamped by the movable driven half-pulley and the fixed driven half-pulley to be close to a region between the movable driven half-pulley and the fixed driven half-pulley; and wherein when the control signal is a power restoration command, the second electrical control device applies a fourth corresponding force to the movable driving half-pulley, to enable the movable driving half-pulley and the fixed driving half-pulley to re-clamp the driving end of the transmission belt at a certain time to be close to a half-pulley center region between the movable driving half-pulley and the fixed driving half-pulley.

23. The electrical control belt continuously variable transmission system of claim 19, further comprising a fixed driving half-pulley boss installed in a half-pulley center region of the fixed driving half-pulley, wherein the fixed driving half-pulley is fixed to and supported by the input shaft by the fixed driving half-pulley boss, and the movable driving half-pulley is mounted onto the fixed driving half-pulley boss and is supported by the input shaft in a manner that the movable driving half-pulley moves along the axial direction of the input shaft; and a fixed driven half-pulley boss installed in a half-pulley center region of the fixed driven half-pulley, wherein the fixed driven half-pulley is fixed to and supported by the output shaft by the fixed driven half-pulley boss, and the movable driven half-pulley is mounted onto the fixed driven half-pulley boss and supported by the output shaft in a manner that the movable driven half-pulley moves along the axial direction of the output shaft.

24. The electrical control belt continuously variable transmission system of claim 23, further comprising a bump installed on the fixed driven half-pulley boss of the fixed driven half-pulley that pre-props against the movable driven half-pulley and acts as a threshold position to which the movable driven half-pulley moves along the axial direction of the output shaft toward the fixed driven half-pulley.

25. The electrical control belt continuously variable transmission system of claim 19, wherein the movable driven half-pulley comprises a first thrust bearing, and the first electrical control device comprises a first electric motor, a first worm, a first worm gear, a first gear reduction unit, and a first helical gear unit, wherein the first electric motor drives the first helical gear unit to move axially through the first worm, the first worm gear, and the first gear reduction unit, such that the first helical gear unit applies a force to the first thrust bearing and keeps applying toward the fixed driven half-pulley the acting force to the movable driven half-pulley.

26. The electrical control belt continuously variable transmission system of claim 19, wherein the movable driving half-pulley comprises a second thrust bearing, and the second electrical control device comprises a second electric motor, a second worm, a second worm gear, a second gear reduction unit, and a second helical gear unit, wherein the second electric motor drives the second helical gear unit according to the control signal through the second worm, the second worm gear, and the second gear reduction unit, such that the second helical gear unit applies a force to the second thrust bearing, and thereby applies the corresponding force to the movable driving half-pulley.

27. The electrical control belt continuously variable transmission system of claim 19, wherein the output shaft outputs the rotating power to the external load unit by using a transmission gear unit and a transmission shaft that amplifies torsion.
